(19) United States
(12) Patent Application Publication
(10) Pub. No.: US 2002/0094075 A1
(43) Pub. Date: Jul. 18, 2002

(54) Method and system for managing internet call centers

(75) Inventors: Avi Levy, Hertzliya (IL); David Sharabani, Ramat Gan (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: TELESPEAR (MASHOV) TECHNOLOGIES LTD.

(21) Appl. No.: 10/046,165

(22) Filed: Jan. 16, 2002

Related U.S. Application Data
(60) Provisional application No. 60/261,194, filed on Jan. 16, 2001.

(51) Int. Cl. H04M 3/00; H04M 5/00

(52) U.S. Cl. 379/265.09

(57) ABSTRACT

A PBX-based call center retrofitted to enable the center's agents to handle both conventional telephonic calls via a PBX and data sessions on a computer network, and a method for its use. Each agent is supplied with a telephone, a computer, and an agent identification unit (AIU) for sending network identification details of the computer as outbound telephony signals to the PBX via the telephone. When a server receives an incoming data packet requesting the establishment of a data session with an agent, an incoming call generator (ICG) sends a ring signal to the PBX to request a link to an agent's telephone. When the selected agent answers the designated telephone, the ICG sends to the designated telephone interrogation telephony signals including a request for the network identification details. In response, the AIU sends the network identification details as identification telephony signals.

This is a continuation-in-part of US Provisional Patent Application No. 60/261,194 filed Jan. 16, 2001.

### FIELD AND BACKGROUND OF THE INVENTION

The present invention is a method, and related hardware, for adding Internet capabilities to a conventional telephonic call center.

FIG. 1 shows a conventional telephonic call center 10, for example for enabling agents to field telephone calls from callers responding to an advertising campaign. The callers use their telephones 12 to call call center 10 via a public switched telephone network (PSTN) 14. At call center 10, the incoming calls are directed to telephones 18 of call center agents by a private branch exchange (PBX) 16. The capabilities of call center 10 also typically include automatic call distribution (ACD), customer relationship management (CRM), billing, call monitoring, etc.

With the advent of technology such as Voice-Over-IP, Web-Collaboration, Chat, E-mail, Push-Pages etc. for using packet switching to send both voice and data over a computer network such as the Internet, it would be highly advantageous to have a way to modify call center 10 to handle both conventional telephone calls and calls via the Internet, without proprietary connections to existing telephony equipment and with minimal additional equipment, and in particular without modifying PBX 16.

### SUMMARY OF THE INVENTION

The examples presented herein are directed towards the establishment of a data session between a caller and an agent via the Internet. Nevertheless, the scope of the present invention includes the establishment of such data sessions via computer networks generally. The Internet is to be considered merely an example of one such computer network.

According to the present invention there is provided a method of establishing a data session via a computer network between a caller and one of a plurality of agents, each agent having a respective telephone, the method including the steps of: (a) providing a PBX for routing incoming telephone calls to the agents' telephones; (b) providing each telephone with a respective computer that has respective network identification details; (c) receiving, via the computer network, an inbound data packet from the caller requesting that the data session be established; (d) generating interrogation telephony signals corresponding to the inbound data packet; (e) sending the interrogation telephony signals to one of the telephones, via the PBX; and (f) sending identification telephony signals, corresponding to at least a portion of the network identification details of the respective computer of the one telephone, from the one telephone to the PBX, in response to the interrogation telephony signals.

According to the present invention there is provided a call center for establishing data sessions via a computer network between callers and a plurality of agents, including: (a) for each agent: (i) a respective telephone, and (ii) a respective computer that has respective network identification details; (b) a PBX for exchanging telephony signals with the telephones; and (c) for each computer, an agent identification unit for sending identification telephony signals, that correspond to at least a portion of the respective network identification details, to the PBX via the respective telephone.

According to the present invention there is provided a call center for establishing data sessions via a computer network between callers and a plurality of agents, including: (a) for each agent: (i) a respective telephone, and (ii) a respective computer that has respective network identification details; (b) a PBX for exchanging telephony signals with the telephone; (c) a server for receiving incoming data packets from the computer network that indicate that respective callers wish to establish data sessions with agents; and (d) an incoming call generator for, for each incoming data packet: (i) requesting, via the PBX, a respective telephonic link to one of the telephones, and (ii) in response to an indication that the one telephone has been designated for the respective telephonic link, sending, to the one telephone, interrogation telephony signals that include a request for identification telephony signals that correspond to the respective network identification details of the respective computer of the one telephone.

As used herein, the term “telephony signals” refers to the audio-band electrical signals conventionally transmitted and received by telephones, including but not limited to analog electrical signals and DTMF signals. The telephony signals that are sent from the incoming call generator to the telephones and the agent identification units are herein called “request” telephony signals; and the telephony signals that are sent from the agent identification units to the incoming call generator are herein called “identification” telephony signals.

Preferably, the interrogation telephony signals include a ring signal. Preferably, the interrogation telephony signals also include a request for a telephonic response that includes the identification telephony signals.

Preferably, the respective network identification details of each computer include a respective network address of the computer, and the portion of the network identification details to which the identification telephony signals correspond include the network address of the respective computer of the telephone to which the interrogation telephony signals are sent. Preferably, the network addresses are logical addresses, for example IP addresses, of the computers.

Preferably, the method of the present invention includes the further steps of: (g) for each computer, storing the respective network identification details in digital form in the computer; and (h) translating the at least portion of the network identification details of the respective computer of the one telephone into the identification telephony signals, prior to the sending of the identification telephony signals.

Preferably, the method of the present invention includes the further steps of (g) translating at least a portion of the identification telephony signals into an outbound data packet; and (h) sending the outbound data packet to the caller via the computer network.

Preferably, the network identification details are stored in the computers in digital form. Preferably, the agent identification units are operative to translate the relevant portions of their respective network identification details from digital form into the corresponding identification telephony signals.

Preferably, the requesting of the respective telephone link by the incoming call generator includes sending a ring signal to the PBX. In response to the ring signal, the PBX designates a telephone to accept the request.

Preferably, the call center of the present invention includes both the incoming call generator and the agent identification units, as well as the server. In response to the interrogation telephony signals, the agent identification unit of the designated telephone sends corresponding identification telephony signals to the incoming call generator via the PBX. The incoming call generator then translates the identification telephony signals into a corresponding outbound data packet and sends the outbound data packet, via the computer network, to the caller that sent the incoming data packet.

### BRIEF DESCRIPTION OF THE DRAWINGS

The invention is herein described, by way of example only, with reference to the accompanying drawings, wherein:

FIG. 1 (prior art) is a high level block diagram of a conventional telephonic call center;

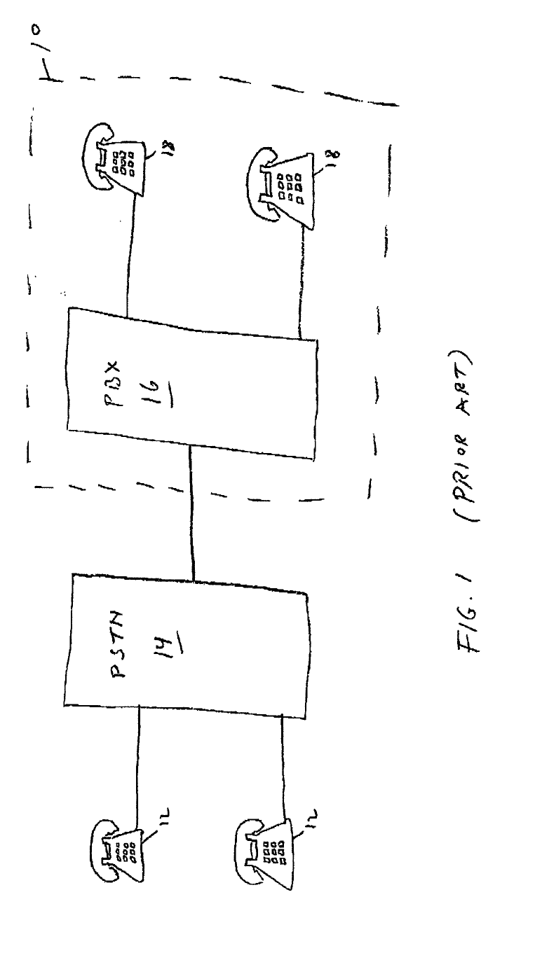

FIG. 2 is a high level block diagram of a call center of the present invention;

FIG. 3 is a block diagram of an agent identification unit;

FIG. 4 is a block diagram of an incoming call generator.

### DESCRIPTION OF THE PREFERRED EMBODIMENTS

The present invention is of hardware that can be retrofitted to a conventional telephonic call center to upgrade that call center to an Internet call center, and of the method by which the upgraded call center is managed.

The principles and operation of Internet call center management according to the present invention may be better understood with reference to the drawings and the accompanying description.

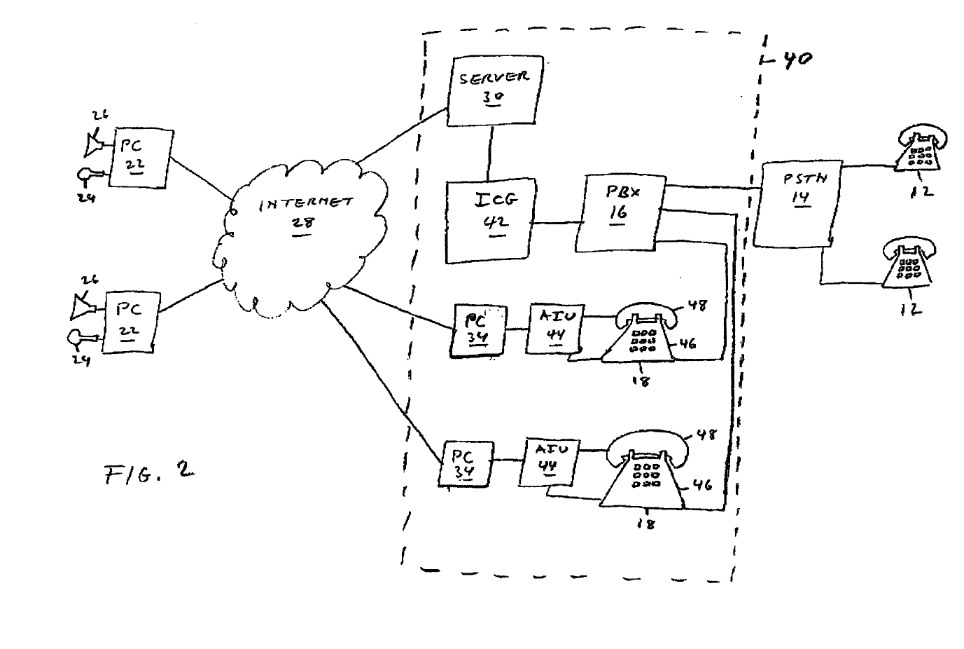

Referring again to the drawings, FIG. 2 is a high level block diagram of a call center 40 of the present invention. Call center 40 is call center 10 upgraded according to the present invention to handle data sessions such as IP sessions via the Internet 28 as well as conventional telephone calls.

The data sessions are initiated by outside callers using equipment such as personal computers 22. The scenario that is used herein to explain the present invention is one in which the outside callers are seeking real-time, on-line support from the agents of call center 40 for a computer program that the callers run on their personal computers 22; although it should be understood that this scenario is merely an example of one application of the present invention, and that the callers could be submitting callback requests, or indeed could be requesting any kind of service that can be handled by a call center.

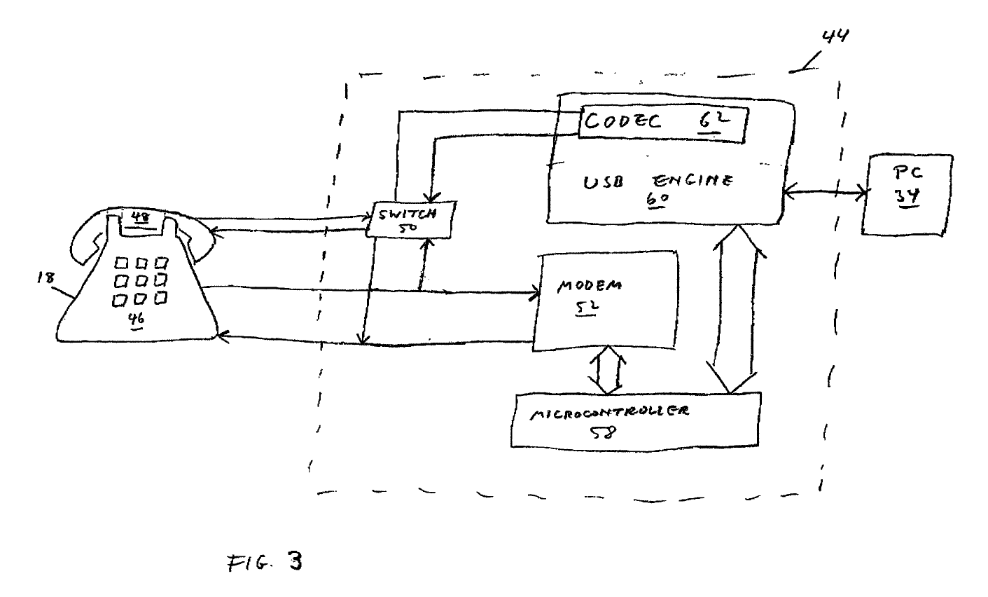

Call center 40 includes, in addition to PBX 16 and agent telephones 18, two classes of new hardware. The first class of hardware includes hardware oriented towards exchange of data packets via the Internet 28, specifically, a server 30 and, for each agent, a respective personal computer 35. A caller needing real-time assistance in using the computer program clicks on the designated portion of a Web page in the Web site of call center 40, thereby sending to server 30 a request to initiate a data session with one of the agents of call center 40. The request is in the form of a packet that includes caller identification details such as the IP address of the caller's personal computer 22. In each personal computer 34 are stored network identification details of that personal computer 34 that are needed to set up a data session between the agent and a caller. At a minimum, these details include the logical address of that personal computer 34. Typically, the logical addresses of personal computers 34 are IP addresses. The second class of hardware includes the hardware units of the present invention: an incoming call generator (ICG) 42 and an agent identification unit (AIU) 44. Also designated by their own reference numerals in FIG. 3 are bases 46 and handsets 48 of agent telephones 18. Equivalently, telephones 18 may include headsets instead of handsets 48.

When server 30 receives a request packet from a caller using one of personal computers 22, server 30 sends a request for an agent to ICG 42. In response to this request, ICG 42 sends a ring signal to PBX 16, which designates a telephone 18 to forward the incoming call to and sends the ring signal to the designated telephone 18. Other facilities of call center, such as ACD, call monitoring, billing and CRM, may be involved in the selection process. ICG 42 keeps ringing until ICG 42 detects an off-hook condition, or until a predetermined wait time has elapsed, as determined either by ICG 42 itself or by server 30. The off-hook condition constitutes an indication that a telephone 18 has been designated to receive the incoming request. Typically, the off-hook condition is generated by the designated telephone 18, for example, when the agent assigned to the designated telephone 18 picks up handset 48 of that telephone 18 (or, if telephone 18 is equipped with a headset instead of a handset 48, when the agent presses the appropriate button on base 46 of telephone 18). Alternatively, the off-hook condition is generated by PBX 16 itself before transferring the call to the designated agent. Upon detecting the off-hook signal, ICG 42 starts sending telephony signals that include requests for the network identification details of the agent's personal computer 34. These signals may be audio band electrical signals, generated using an audio modem, or DTMF signals, generated using a DTMF modem. ICG 42 continues to generate these signals until the appropriate reply is received from AIU 44 of the selected telephone 18 or until a predetermined wait time has elapsed, as determined either by ICG 42 itself or by server 30.

When the agent assigned to that agent telephone 18 picks up handset 48 of that agent telephone 18 in response to the ring signal, the agent's AIU 44 starts listening to the incoming telephony signals from PBX 16 for signals that include a request generated by ICG 42 for the network identification details of the agent's personal computer 34. Upon detecting such signals, the agent's AIU 44 sends back to ICG 42, via PBX 16, identification telephony signals that include the network identification details that are relevant to setting up a data session. These signals may be audio band electrical signals, generated using an audio modem, or DTMF signals, generated using a DTMF modem. For this purpose, the agent's AIU 44 retrieves the relevant portion of the network identification details from the agent's personal computer 34. Alternatively, the relevant portion of the network identification details is downloaded from the agent's personal computer 34 into the agent's AIU 44 when the initial connection between the agent's personal computer 34 and the agent's AIU 44 is established. ICG 42 translates the identification telephony signals into an acknowledgement packet that includes the relevant portion of the network identification details, including at least the logical address of the agent's personal computer 34. ICG 42 then and sends the acknowledgement packet to server 30. Server 30 sends the relevant portion of the network identification details to the caller via the Internet 28, either in the form of the acknowledgement packet itself or in an equivalent form. As soon as the caller's personal computer 22 is aware of the logical address of the agent's personal computer 34, the caller's personal computer 22 can initiate a data session with the agent's personal computer 34 in which personal computers 22 and 34 exchange data packets via the Internet 28.

Optionally, the data session is a Voice-Over-IP session, including oral communication between the caller and the agent. For this purpose, the caller's personal computer 22 is equipped with a microphone 24 and a speaker 26 (or with equivalent equipment such as a headset); and the agent's AIU 44 is configured as an interface between the agent's personal computer 34 and the agent's telephone 18 that enables the use of the agent's handset 48 (or the agent's headset, if the agent's telephone 18 is so equipped) as a combined microphone-speaker.

FIG. 3 is a block diagram of an AIU 44 and its relationship to the associated telephone 18 and the associated personal computer 34. AIU 44 includes a switch 50, a modem 52, a microcontroller 58, and a USB engine 60 that includes a CODEC 62. As noted above, modem 52 may be either an audio band modem for generating and receiving audio band electrical signals or a DTMF modem for generating and receiving DTMF signals. Microcontroller 58 controls the overall operation of AIU 44, and in particular tells modem 52 whether to receive from telephone 18 or transmit to telephone 18. USB engine 60 retrieves the network identification details of personal computer 34 from personal computer 34. Via CODEC 62 and switch 50, USB engine 60 also sets headset 48 for either telephonic communication via base 46 of telephone 48 or Voice-Over-IP communication via personal computer 34.

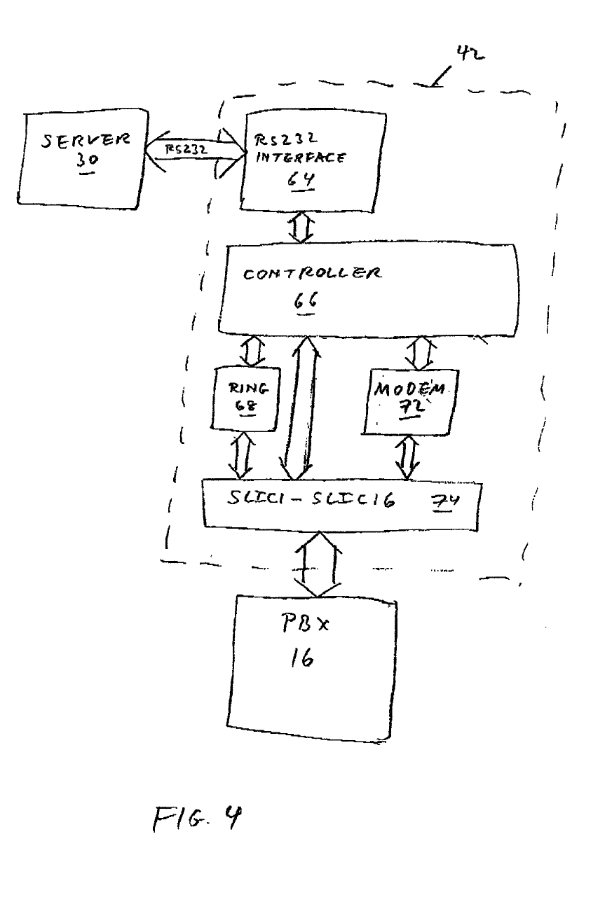

FIG. 4 is a block diagram of ICG 42 and its relationship to server 30 and PBX 16. ICG 42 includes an interface 64 to server 30, a controller 66, a ring generator 68, a modem 72 and a set 74 of 16 telephone lines (SLIC lines in this example) to PBX 16. Interface 64 is illustrated as an RS232 interface, but could be any suitable interface, for example an Ethernet for IP connection. As noted above, modem 72 may be either an audio band modem for generating and receiving audio band electrical signals or a DTMF modem for generating and receiving DTMF signals. Controller 66 controls the overall operation of ICG 42 and in particular designates agents' telephones 18 by selecting their respective telephone lines. Ring generator 68 generates the ring signal. Modem 72 generates the telephony signals that include requests for network identification details.

While the invention has been described with respect to a limited number of embodiments, it will be appreciated that many variations, modifications and other applications of the invention may be made.

What is claimed is:

1. A method of establishing a data session via a computer network between a caller and one of a plurality of agents, each agent having a respective telephone, the method comprising the steps of:
(a) providing a PBX for routing incoming telephone calls to the agents' telephones;
(b) providing each telephone with a respective computer that has respective network identification details;
(c) receiving, via the computer network, an inbound data packet from the caller requesting that the data session be established;
(d) generating interrogation telephony signals corresponding to said inbound data packet;
(e) sending said interrogation telephony signals to one of the telephones, via said PBX; and
(f) sending identification telephony signals, corresponding to at least a portion of said network identification details of said respective computer of said one telephone, from said one telephone to said PBX, in response to said interrogation telephony signals.

2. The method of claim 1, wherein said interrogation telephony signals include a ring signal.

3. The method of claim 1, wherein said interrogation telephony signals include a request for a telephonic response that includes said identification telephony signals.

4. The method of claim 1, wherein said respective network identification details of each computer include a respective network address of said each computer, and wherein said at least portion of said network identification details includes said network address of said respective computer of said one telephone.

5. The method of claim 4, wherein said network address is a logical address of said each computer.

6. The method of claim 5, wherein said logical address is an IP address.

7. The method of claim 1, further comprising the steps of:
(g) for each computer, storing said respective network identification details in digital form in said each computer; and
(h) translating said at least portion of said network identification details of said respective computer of said one telephone into said identification telephony signals, prior to said sending of said identification telephony signals.

8. The method of claim 1, further comprising the steps of:
(g) translating at least a portion of said identification telephony signals into an outbound data packet; and
(h) sending said outbound data packet to the caller via the computer network.

9. A call center for establishing data sessions via a computer network between callers and a plurality of agents, comprising:
(a) for each agent:
(i) a respective telephone, and
(ii) a respective computer that has respective network identification details;
(b) a PBX for exchanging telephony signals with said telephones; and
(c) for each said computer, an agent identification unit for sending identification telephony signals, that correspond to at least a portion of said respective network identification details, to said PBX via said respective telephone.

10. The call center of claim 9, wherein, for each said computer, said respective network identification details are stored in digital form in said each computer; and wherein, for each said computer, said agent identification unit is operative to translate said at least portion of said respective network identification details from said digital form into said corresponding identification telephony signals.

11. The call center of claim 9, further comprising:
(d) a server for receiving incoming data packets from the computer network that indicate that respective callers wish to establish data sessions with agents; and
(e) an incoming call generator for, for each incoming data packet:
(i) requesting, via said PBX, a respective telephonic link to one of said telephones, and
(ii) in response to an indication that said one telephone has been designated for said respective telephonic link, , sending, to said one telephone, interrogation telephony signals that include a request for said agent identification unit of said one telephone to send said corresponding identification telephony signals.

12. The call center of claim 11, wherein said requesting of said respective telephonic link includes sending a ring signal to said PBX.

13. The call center of claim 11, wherein said respective agent identification unit of said one telephone sends said corresponding identification telephony signals to said incoming call generator via said PBX in response to said interrogation telephony signals.

14. The call center of claim 13, wherein said incoming call generator is further operative, for each said incoming data packet:
(iii) to translate said corresponding identification telephony signals into a corresponding outbound data packet; and
(iv) to send said outbound data packet to said respective caller of said each incoming data packet via the computer network.

15. A call center for establishing data sessions via a computer network between callers and a plurality of agents, comprising:
(a) for each agent:
(i) a respective telephone, and
(ii) a respective computer that has respective network identification details;
(b) a PBX for exchanging telephony signals with said telephone;
(c) a server for receiving incoming data packets from the computer network that indicate that respective callers wish to establish data sessions with agents; and
(d) an incoming call generator for, for each incoming data packet:
(i) requesting, via said PBX, a respective telephonic link to one of said telephones, and
(ii) in response to an indication that said one telephone has been designated for said respective telephonic link, sending, to said one telephone, interrogation telephony signals that include a request for identification telephony signals that correspond to said respective network identification details of said respective computer of said one telephone.

16. The call center of claim 15, wherein said requesting of said respective telephonic link includes sending a ring signal to said PBX.

17. The call center of claim 15, wherein said incoming call generator is further operative, for each said incoming data packet:
(iii) to translate said corresponding identification telephony signals into a corresponding outbound data packet; and
(iv) to send said outbound data packet to said respective caller of said each incoming data packet via the computer network.

18. The call center of claim 15, further comprising:
(e) for each agent, an agent identification unit for sending said identification telephony signals to said incoming call generator, via said respective telephone of said each agent and via said PBX, in response to said interrogation telephony signals.

19. The call center of claim 18, wherein, for each said computer, said respective network identification details are stored in digital form in said each computer; and wherein, for each said computer, said agent identification unit is operative to translate said respective network identification details from said digital form into said corresponding identification telephony signals.
